(19) United States
(12) Patent Application Publication
(10) Pub. No.: US 2008/0173327 A1
(43) Pub. Date: Jul. 24, 2008

(54) TWO-FLUID NOZZLE, SUBSTRATE PROCESSING APPARATUS, AND SUBSTRATE PROCESSING METHOD

(76) Inventor: Masahiro Miyagi, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/954,738

(22) Filed: Dec. 12, 2007

(30) Foreign Application Priority Data
Dec. 15, 2006 (JP) 2006-337765

(51) Int. Cl. B08B 3/10; B05B 5/06

(52) U.S. Cl. 134/1.3; 204/661; 239/706; 239/423

(57) ABSTRACT

A substrate processing apparatus has a two-fluid nozzle having an inner cylindrical member and an outer cylindrical member. Gas flows in the inner cylindrical member which is a gas passage and the processing liquid downwardly flows in a processing liquid passage constituted of the inner and outer cylindrical members. The gas and the processing liquid are mixed in a mixing area below the inner cylindrical member to generate fine droplets, and the droplets are ejected from an outlet of a lower end of the outer cylindrical member onto a substrate. Charge is induced on the processing liquid by generating an electric potential difference between a first electrode provided in the gas passage and a second electrode provided in the processing liquid passage, to generate charged droplets. In the nozzle, the first electrode is isolated from the processing liquid with a simple construction, and the droplets can be charged efficiently.

### BACKGROUND OF THE INVENTION

1. Field of the Invention

The present invention relates to a two-fluid nozzle for ejecting droplets, and especially relates to a two-fluid nozzle used in processing a substrate by ejecting droplets of processing liquid onto the substrate and a technique for processing a substrate with use of the two-fluid nozzle.

2. Description of the Background Art

Conventionally, in manufacturing process of a semiconductor substrate (hereinafter, simply referred to as “substrate”), various processings are performed by ejecting processing liquid onto a substrate. For example, in a cleaning process of a substrate, unwanted particles and the like adhering on the surface of the substrate are removed by ejecting cleaning solution such as pure water onto the substrate.

In such a cleaning process, it has been known that the whole surface of the substrate on which an insulating film is formed is charged by contacting with pure water with a high resistivity. For example, the substrate is negatively charged in a case where an oxide film is formed on a surface of a substrate and conversely, the substrate is positively charged in a case where a resist film is formed on a surface of a substrate. When a surface charge of the substrate is large, there is a possibility of occurrence of re-adhesion of unwanted particles or damage on wiring due to electric discharge during and after cleaning or the like. Therefore, various techniques for suppressing charging of the substrate in a substrate processing apparatus have been suggested.

For example, Japanese Patent Application Laid-Open No. 2002-184660 (Document 1) discloses a technique for suppressing charging of a surface of a substrate in an apparatus where ionized nitrogen (N⁺) gas is purged into a processing space above the substrate, and the substrate is cleaned by applying cleaning solution onto the rotating substrate. Japanese Patent Application Laid-Open No. 2005-183791 (Document 2) discloses a technique for suppressing charging of surfaces of substrates in an apparatus where the substrates are dipped into cleaning solution stored in a process bath and a CO₂ (carbon dioxide)-dissolved water where CO₂ gas is dissolved into pure water is ejected onto the substrates in exchanging of the cleaning solution.

Japanese Patent Application Laid-Open No. 10-149893 (Document 3) discloses an apparatus for removing static electricity of charged substances, where pure water is ejected from a nozzle at high speed to generate fine droplets of the pure water which are charged by flow friction with the nozzle and the charged droplets are ejected onto the charged substances. The apparatus can be applied to a charged semiconductor substrate after cleaning.

“Charged Fog Generated from Collision between Water Jet and Silicon Wafer” by Kazuaki ASANO and Hirofumi SHIMOKAWA (IEJ (The Institute of Electrostatics Japan) transactions' 00 (March 2000), IEJ, March 2000, pp. 25-26) describes experiments on a generation process of charged fog which is generated when a jet of pure water ejected from a nozzle collides with a silicon wafer. In an apparatus used in the experiments, an induction electrode is arranged in a path of ejection of pure water and an amount of charging of jet is controlled to change an amount of charging of charged fog.

However, in the cleaning process performed in the ionized gas atmosphere as disclosed in Document 1, it is difficult to apply the ionized gas onto the surface of the substrate continuously and efficiently, and there is a limitation in suppressing charging of the substrate during cleaning process. In the apparatuses shown in Documents 2 and 3, it is not possible to suppress charging of the substrate during cleaning process.

### SUMMARY OF THE INVENTION

The present invention is intended for a two-fluid nozzle for ejecting droplets of processing liquid onto an object to be processed. It is an object of the present invention to efficiently charge droplets of processing liquid.

The two-fluid nozzle according to the present invention comprises: a processing liquid passage through which processing liquid flows; a gas passage through which gas flows; a droplet generation part which mixes the processing liquid from the processing liquid passage and the gas from the gas passage to generate droplets and ejects the droplets toward a predetermined ejection direction together with the gas; a first electrode provided in the gas passage in the vicinity of the droplet generation part; and a second electrode which contacts the processing liquid in the processing liquid passage or the droplet generation part, and in the nozzle, an electric potential difference is generated between the first electrode and the second electrode. According to the present invention, the first electrode is isolated from the processing liquid with a simple construction, and the droplets of the processing liquid can be charged efficiently. As a result, it is possible to suppress charging of the substrate during processing, in the case that the substrate is processed by ejecting the droplets of the processing liquid from the two-fluid nozzle onto the substrate.

According to a preferred embodiment of the present invention, the droplet generation part comprises a cover covering a mixing area of the processing liquid and the gas and having an ejection outlet, and the second electrode is provided in the cover. According to an aspect of the present invention, the gas is ejected from the gas passage toward a central portion of the mixing area, the processing liquid from the processing liquid passage is supplied around flow of the gas in the mixing area, and the second electrode is a ring shape surrounding the flow of the gas. It is thereby possible to reduce nonuniformity of charge in the entire droplets. According to another aspect of the present invention, the cover and the second electrode are formed as one conductive member and it is possible to simplify the construction of the nozzle.

According to another preferred embodiment of the present invention, the second electrode is formed of conductive resin or conductive carbon, to thereby prevent contamination of the processing liquid.

The present invention is also intended for a substrate processing apparatus for processing a substrate. It is an object of the present invention to suppress charging of a substrate during processing.

The substrate processing apparatus according to the present invention comprises: a holding part for holding a substrate; a two-fluid nozzle for ejecting droplets of processing liquid onto a main surface of the substrate; and a power supply connected to the two-fluid nozzle, and in the apparatus, the two-fluid nozzle comprises: a processing liquid passage through which processing liquid flows; a gas passage through which gas flows; a droplet generation part which mixes the processing liquid from the processing liquid passage and the gas from the gas passage to generate droplets and ejects the droplets toward a predetermined ejection direction together with the gas; a first electrode provided in the gas passage in the vicinity of the droplet generation part; and a second electrode which contacts the processing liquid in the processing liquid passage or the droplet generation part, and the power supply generates an electric potential difference between the first electrode and the second electrode. According to the present invention, it is possible to suppress charging of the substrate during processing.

The more preferable substrate processing apparatus further comprises: a surface electrometer for measuring an electric potential on the main surface of the substrate; and a control part for controlling an electric potential difference generated between the first electrode and the second electrode on the basis of an output from the surface electrometer in parallel with ejection of the droplets from the two-fluid nozzle. It is thereby possible to efficiently suppress charging.

The present invention is also intended for a substrate processing method of processing a substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a substrate processing apparatus in accordance with a first preferred embodiment;

FIG. 2 is a longitudinal sectional view of a nozzle;

FIG. 3 is a flowchart showing an operation flow for cleaning a substrate;

FIG. 4 is a view showing another example of the nozzle;

FIGS. 5 and 6 are views each showing still another example of the nozzle;

FIG. 7 is a view showing a construction of a substrate processing apparatus in accordance with a second preferred embodiment;

FIG. 8 is a flowchart showing a part of an operation flow for cleaning a substrate; and

FIG. 9 is a view showing a construction of a substrate processing apparatus in accordance with a third preferred embodiment.

### DESCRIPTION OF THE PREFERRED EMBODIMENTS

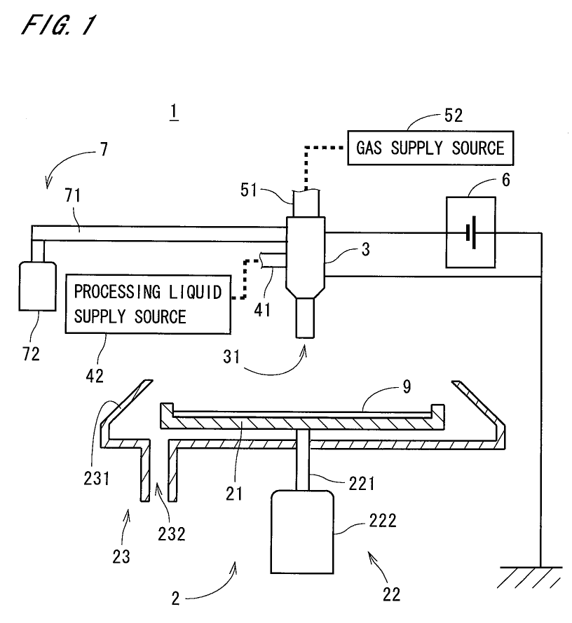

FIG. 1 is a view showing a construction of a substrate processing apparatus 1 in accordance with the first preferred embodiment of the present invention. The substrate processing apparatus 1 is a substrate cleaning apparatus where a cleaning process is performed by applying nonconductive pure water (hereinafter, referred to as “processing liquid”) onto a semiconductor substrate 9 (hereinafter, simply referred to as “substrate 9”) on which an oxide film which is an insulating film is formed, to remove foreign substances such as unwanted particles adhering on a surface of the substrate 9.

As shown in FIG. 1, the substrate processing apparatus 1 has a substrate holding part 2 for holding the substrate 9 to be processed in contact with a lower main surface of the substrate 9, a two-fluid nozzle (hereinafter, referred to as “nozzle”) 3 which is positioned above the substrate 9 to eject droplets of the processing liquid onto an upper main surface of the substrate 9 (hereinafter, referred to as “upper surface”), a processing liquid supply source 42 for supplying the processing liquid to the nozzle 3 through a processing liquid supply pipe 41, a gas supply source 52 for supplying N₂ gas, air or the like which is carrier gas to the nozzle 3 through a gas supply pipe 51, independently of the processing liquid supply source 42, a power supply 6 for applying a potential to a later-discussed electrode which is provided in the nozzle 3, and a nozzle moving mechanism 7 for moving the nozzle 3 relatively to the substrate 9 in parallel with the upper surface of the substrate 9. In FIG. 1, a part of the substrate holding part 2 is shown cross-sectionally for convenience of illustration.

The substrate holding part 2 has a chuck 21 for holding the approximately disk-shaped substrate 9 in contact with the lower main surface and the periphery of the substrate 9, a rotation mechanism 22 for rotating the substrate 9, and a process cup 23 covering the circumference of the chuck 21. The rotation mechanism 22 includes a shaft 221 coupled to a lower surface of the chuck 21 and a motor 222 for rotating the shaft 221. By driving the motor 222, the substrate 9 rotates together with the shaft 221 and the chuck 21. The process cup 23 has a side wall 231 which is positioned around the circumference of the chuck 21 to prevent the processing liquid applied onto the substrate 9 from splashing around, and a drain outlet 232 which is provided in a lower part of the process cup 23 and drains the processing liquid applied onto the substrate 9.

The nozzle moving mechanism 7 has an arm 71 whose top end is fixed to the nozzle 3 and a motor 72 for oscillating the arm 71. By driving the motor 72, the nozzle 3 and the arm 71 reciprocally move in parallel with the upper surface of the substrate 9 in an arc shape close to a straight line in the substrate processing apparatus 1.

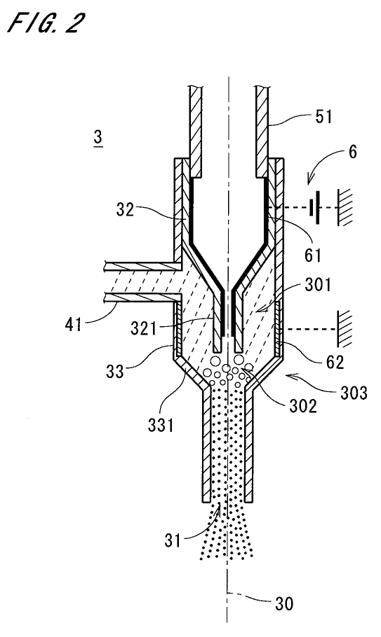

FIG. 2 is a longitudinal sectional view of the nozzle 3. The nozzle 3 is the two-fluid nozzle with internal mixing and has an inner cylindrical member 32 and an outer cylindrical member 33 around the central axis 30 of the nozzle 3 (the central axis of an ejection outlet 31). Although the inner cylindrical member 32 is formed of fluorine-based resin and the outer cylindrical member 33 is formed of quartz, these members may be formed of other material. An upper end of the inner cylindrical member 32 is connected to the gas supply pipe 51, and gas is ejected from a lower end of the inner cylindrical member 32. That is to say, the gas supply pipe 51 and the inner cylindrical member 32 constitute a gas passage through which gas flows in the nozzle 3. A portion close to the lower end of the inner cylindrical member 32 has a small diameter so that the gas is strongly ejected therefrom (the portion is hereinafter referred to as “lower end portion 321”).

A first electrode 61 which is a conductive layer is formed on an inner wall surface of the inner cylindrical member 32 by plating, and the first electrode 61 is connected to a negative electrode of the power supply 6 which is provided outside the nozzle 3. Since the gas and the processing liquid are mixed below the lower end portion 321 of the inner cylindrical member 32 as discussed later, the first electrode 61 is provided at a position which is slightly higher than that of an opening of the lower end of the inner cylindrical member 32 or is provided at a position which is still higher than the above position where the first electrode 61 is provided, in order to prevent the processing liquid from adhering on the first electrode 61.

An upper portion of the outer cylindrical member 33 is in contact with the inner cylindrical member 32, and an annular gap space 301 is formed between the outer cylindrical member 33 and the circumference of the lower end portion 321 of the inner cylindrical member 32. The diameter of the outer cylindrical member 33 is decreased below the lower end portion 321 and a lower end of the outer cylindrical member 33 is the ejection outlet 31. The processing liquid supply pipe 41 is connected to an upper portion of the gap space 301 from a side portion of the outer cylindrical member 33, and the processing liquid from the processing liquid supply source 42 (see FIG. 1) is supplied to the gap space 301 and flows downwardly. As described above, in the nozzle 3, the processing liquid supply pipe 41 and the inner cylindrical member 32 and the outer cylindrical member 33 which form the gap space 301 constitute a processing liquid passage through which the processing liquid flows. In a mixing area 302 below the lower end portion 321, the gas is ejected from the gas passage toward the central portion of the mixing area 302, the processing liquid from the processing liquid passage is supplied around flow of the gas, and the processing liquid and the gas are thereby mixed to generate fine droplets. Since a part of the outer cylindrical member 33 is a cover 331 covering the mixing area 302 and having the ejection outlet 31, the generated droplets are strongly ejected together with the gas from the ejection outlet 31 toward an ejection direction which is a lower direction along the central axis 30. In the following description, the lower end portion 321 and the cover 331 positioned around the lower end portion 321, both of which generate the droplets and determine the ejection direction, are referred to as a “droplet generation part 303”.

A ring-shaped second electrode 62 about the central axis 30 is buried in the cover 331 and the second electrode 62 is grounded. An electric potential difference is thereby generated between the first electrode 61 and the second electrode 62 by the power supply 6. Since the second electrode 62 contacts the processing liquid, the processing liquid is positively charged by the electric potential difference and fine droplets which are positively charged are ejected from the ejection outlet 31. In other words, the first electrode 61 provided in the inner cylindrical member 32 functions as an induction electrode which induces charge on the processing liquid in the nozzle 3. The second electrode 62 may be provided at another position contacting the processing liquid in the processing liquid passage or the droplet generation part 303.

The second electrode 62 is formed of glassy conductive carbon such as amorphous carbon or glassy carbon. Since the glassy carbon is hard carbon material with a uniform and dense structure, it has excellent conductivity, chemical resistance, heat resistance, and the like. The second electrode 62 may be formed of conductive resin (for example, conductive PEEK (poly-ether-ether-ketone), or conductive PTFE (poly-tetra-fluoro-ethylene)).

Next discussion will be made on a cleaning process of the substrate 9 in the substrate processing apparatus 1. FIG. 3 is a flowchart showing an operation flow for cleaning the substrate 9. In the substrate processing apparatus 1 shown in FIG. 1, first, after the substrate 9 is held by the chuck 21 of the substrate holding part 2, the motor 222 of the rotation mechanism 22 is driven to start rotation of the substrate 9 (Steps S11, S12). Subsequently, an electric potential difference is generated between the first electrode 61 and the second electrode 62 (Step S13). In the present preferred embodiment, a potential of approximately (−1000) V is applied to the first electrode 61.

Next, the nozzle moving mechanism 7 is driven to start movement (i.e., oscillation) of the nozzle 3 (Step S14), supply of the processing liquid from the processing liquid supply source 42 and supply of the gas from the gas supply source 52 are started and the processing liquid and the gas are mixed in the droplet generation part 303 to generate fine droplets, and therefore the droplets are ejected onto the upper surface of the substrate 9 (Step S15). As described earlier, by generating an electric potential difference between the first electrode 61 and the second electrode 62, positive charge is induced on the processing liquid immediately before changing into droplets in the droplet generation part 303, to charge the droplets positively.

The nozzle 3 repeats reciprocal movement at a constant speed between the center and the periphery of the substrate 9 in an arc shape close to a straight line, in parallel with the upper surface of the substrate 9, while ejecting the droplets onto the upper surface of the rotating substrate 9. With this operation, the droplets of pure water which is the processing liquid are ejected over the whole upper surface of the substrate 9, to remove foreign substances such as unwanted particles adhering on the upper surface. In the substrate processing apparatus 1, while ejection of the droplets onto the substrate 9 is performed, induction of charge on the processing liquid in the nozzle 3 is parallelly and continuously performed.

After ejection onto the substrate 9 is continued for a predetermined time period and the whole upper surface is cleaned, ejection of the droplets from the nozzle 3 and relative movement of the nozzle 3 to the substrate 9 are stopped and generation of the electric potential difference between the first electrode 61 and the second electrode 62 (i.e., induction of charge on the processing liquid in the nozzle 3) is also stopped (Step S16). Rotation of the substrate 9 is continued until the substrate 9 dries and afterwards, rotation of the substrate 9 is stopped (Step S17). The substrate 9 is unloaded from the substrate processing apparatus 1 to complete the cleaning process of the substrate 9 (Step S18).

In the substrate processing apparatus 1, by collision of the fine droplets of the processing liquid with the upper surface of the substrate 9 at high speed, unwanted fine particles such as organic matter adhering on the upper surface can be efficiently removed without damaging a fine pattern formed on the upper surface. Since the two-fluid nozzle is used as the nozzle 3 in the substrate processing apparatus 1, it is possible to easily generate the droplets of the processing liquid and minimize the mechanism for generation and ejection of the droplets.

In the substrate processing apparatus 1, in the case that the substrate 9 is negatively charged when cleaning is performed without induction of charge on the pure water which is the processing liquid, positive charge (i.e., the charge having an opposite polarity to that of the electric potential of the substrate 9 after cleaning is performed without generation of the electric potential difference) is induced on the processing liquid immediately before changing into droplets and the substrate 9 is cleaned by the charged droplets, thereby achieving suppression of charging of the substrate 9 during and after cleaning.

Since induction of charge (charge induction) in the nozzle 3 is continuously performed while cleaning of the substrate 9 is performed in the substrate processing apparatus 1, it is possible to further suppress charging of the substrate 9. Further, since the second electrode 62 is made to a ring shape surrounding the flow of the gas which is ejected toward the central portion of the mixing area 302, nonuniformity of the charge in the entire droplets can be reduced. As a result, it is possible to suppress charging of the substrate 9 almost uniformly with respect to the circumferential direction of the substrate 9.

As shown in FIG. 2, in the nozzle 3, since the first electrode 61 is provided in the inner cylindrical member 32 which is a part of the gas passage and the second electrode 62 is provided at a portion contacting the processing liquid of the outer cylindrical member 33, the portion being a part of the processing liquid passage, the first electrode 61 can be isolated from the processing liquid, with a simple construction without a special design (for example, the first electrode 61 is covered with dielectric material or the like) and the second electrode 62 can be surely brought into contact with the processing liquid. Consequently, charge can be induced on the processing liquid with a simple construction. Additionally, the lower end portion 321 of the inner cylindrical member 32 is extremely close to the droplet generation part 303 and it is therefore possible to perform induction of charge on the processing liquid extremely efficiently.

Since the second electrode 62 is formed of conductive resin or conductive carbon, unlike the case where it is formed of metal, it is possible to prevent the processing liquid from being contaminated because of getting mixed with metal powder or the like or melting of metal, while keeping conductivity of a liquid contact part. As a result, it is possible to improve quality of processing of the substrate 9. From the view point of efficiently applying charge to droplets, it is most preferable that the second electrode 62 is arranged in the cover 331 covering the mixing area 302, as shown in FIG. 2.

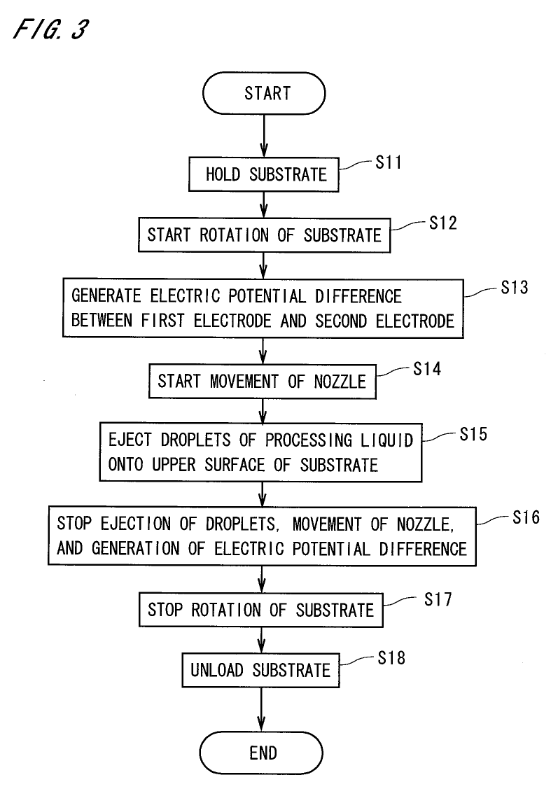

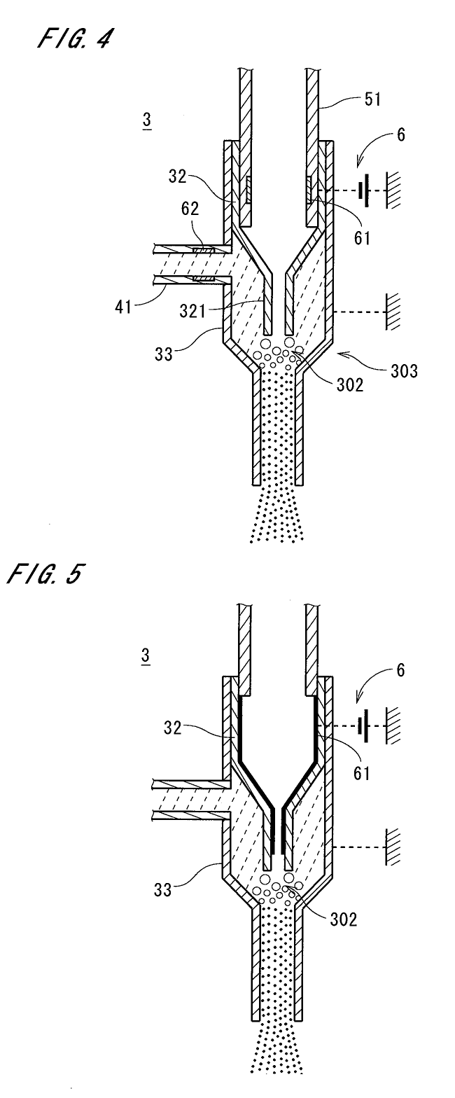

FIG. 4 is a view showing another example of the nozzle 3. In a nozzle 3 of FIG. 4, arrangement of a first electrode 61 and a second electrode 62 is changed from that in the nozzle 3 of FIG. 2. A gas supply pipe 51 is connected to an inner cylindrical member 32 so as to enter into the inner cylindrical member 32, and the ring-shaped first electrode 61 is buried in the inner surface of the gas supply pipe 51 in the nozzle 3 of FIG. 4. The second electrode 62 is arranged in the vicinity of an outer cylindrical member 33 in a processing liquid supply pipe 41. As described above, the first electrode 61 may be provided in various manners so far as it is provided in a gas passage in the vicinity of a droplet generation part 303, and thus droplets of processing liquid can be charged efficiently. The second electrode 62 is not necessarily provided in a member constituting the nozzle 3 but may be disposed in other portion which can be substantially regarded as a part of the nozzle 3.

Though induction efficiency of charge (charge induction efficiency) becomes better as the first electrode 61 and the second electrode 62 are closer to a mixing area 302 in the droplet generation part 303, it is preferable that a distance between the mixing area 302 and the first electrode 61 is made to be equal to or shorter than 5 cm (centimeter), even if the first electrode 61 cannot be arranged in a lower end portion 321 of the inner cylindrical member 32 for convenience of design.

FIG. 5 is a view showing still another example of the nozzle 3. A nozzle 3 of FIG. 5 is different from that of FIG. 2 in that an outer cylindrical member 33 is formed of conductive resin or conductive carbon which is grounded and a second electrode 62 is omitted. As shown in FIG. 5, the outer cylindrical member 33 serving as a cover of a mixing area 303 and the second electrode 62 shown in FIG. 2 may be formed as one conductive member, thereby achieving simplification of the construction of the nozzle 3.

FIG. 6 is a view showing a two-fluid nozzle 3a with external mixing having the same function as the nozzle 3 shown in FIG. 2. The nozzle 3a also has an inner cylindrical member 34 and an outer cylindrical member 35 around the central axis 30, however, the inner cylindrical member 34 is connected to a processing liquid supply pipe 41 and the outer cylindrical member 35 is connected to a gas supply pipe 51. Processing liquid from the processing liquid supply pipe 41 is discharged (ejected) from a discharge outlet 31a at a lower end of the inner cylindrical member 34 through the inner cylindrical member 34. An annular gap space 301 around the central axis 30 is formed between the inner cylindrical member 34 and the outer cylindrical member 35, and gas supplied from the gas supply pipe 51 downwardly flows the gap space 301 to be ejected from an annular ejection outlet 31b at lower ends of the cylindrical members 34, 35 along a direction which tilts toward the central axis 30. In the nozzle 3a, the processing liquid supply pipe 41 and the inner cylindrical member 34 constitute a processing liquid passage through which the processing liquid flows, and the gas supply pipe 51, the outer cylindrical member 35 and the inner cylindrical member 34 constitute a gas passage through which the gas flows.

The processing liquid just discharged from the discharge outlet 31a collides with the gas ejected from the ejection outlet 31b to become fine droplets, and the droplets are ejected toward an ejection direction along the central axis 30. That is to say, a lower part of the inner cylindrical member 34 and a lower part of the outer cylindrical member 35 serve as a droplet generation part which mixes the processing liquid and the gas to generate droplets and ejects the droplets toward the ejection direction together with the gas, and an area below the discharge outlet 31a is a mixing area 302.

A first electrode 61 is buried in a lower portion of the inner surface of the outer cylindrical member 35, and a second electrode 62 is buried in a lower portion of the inner surface of the inner cylindrical member 34. The first electrode 61 is connected to a power supply 6 and the second electrode 62 is grounded. Similarly to the nozzle 3 of FIG. 2, since the first electrode 61 is provided in the gas passage in the nozzle 3a, it is possible to easily prevent the processing liquid from adhering on the first electrode 61. The second electrode 62 is provided in the processing liquid passage and therefore, it can be easily brought into contact with the processing liquid. Further, since the first electrode 61 is provided in the vicinity of an opening end of the gas passage (i.e., in the vicinity of the droplet generation part) like the case of FIG. 2, the first electrode 61 is isolated from the processing liquid with a simple construction, and the droplets can be charged efficiently. Also in the nozzle 3a, since the first electrode 61 is made to a ring shape around the central axis 30, it is possible to uniformize a distribution of charge in the entire droplets with respect to the circumferential direction.

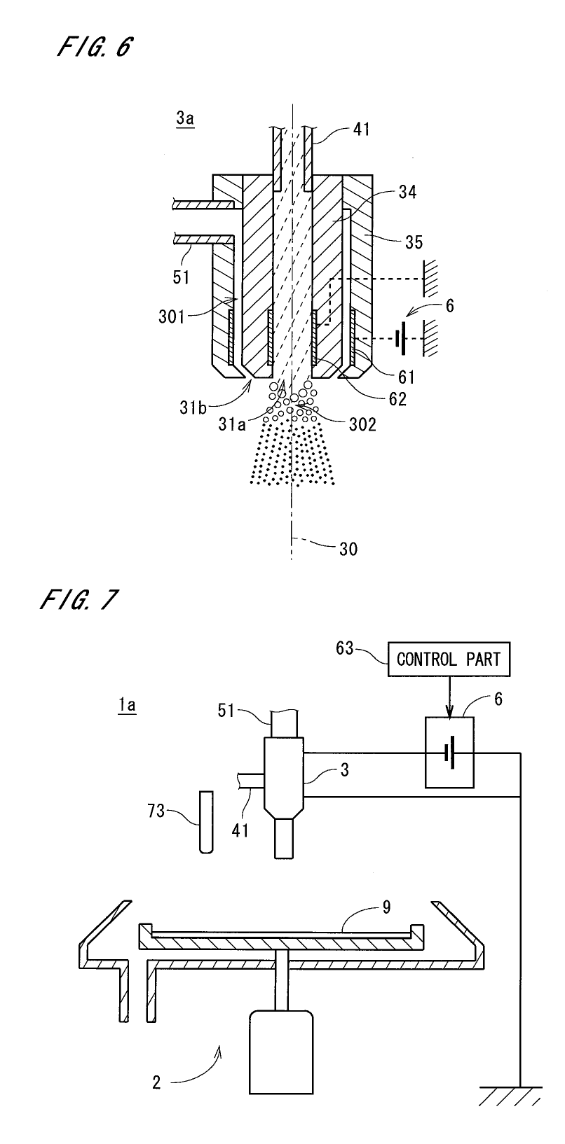

Next, discussion will be made on a substrate processing apparatus 1a in accordance with the second preferred embodiment of the present invention, referring to FIG. 7. The substrate processing apparatus 1a further has a surface electrometer 73 for measuring an electric potential on an upper surface of a substrate 9 and a control part 63 for controlling a potential applied to the first electrode 61 (i.e., an electric potential difference generated between the first electrode 61 and the second electrode 62), in addition to the constituent elements of the substrate processing apparatus 1 shown in FIG. 1. The surface electrometer 73 is attached to the not-shown nozzle moving mechanism (see the reference sign 7 in FIG. 1) and measures an electric potential in the vicinity of an area on the substrate 9 where droplets are ejected. The position of the surface electrometer 73 may be fixed and in this case, a measurement result of the surface electrometer 73 is referred to as a value representing a degree of charging of the substrate 9. The other constituent elements of the substrate processing apparatus 1a are the same as those in FIGS. 1 and 2 and represented by the same reference signs in the following discussion.

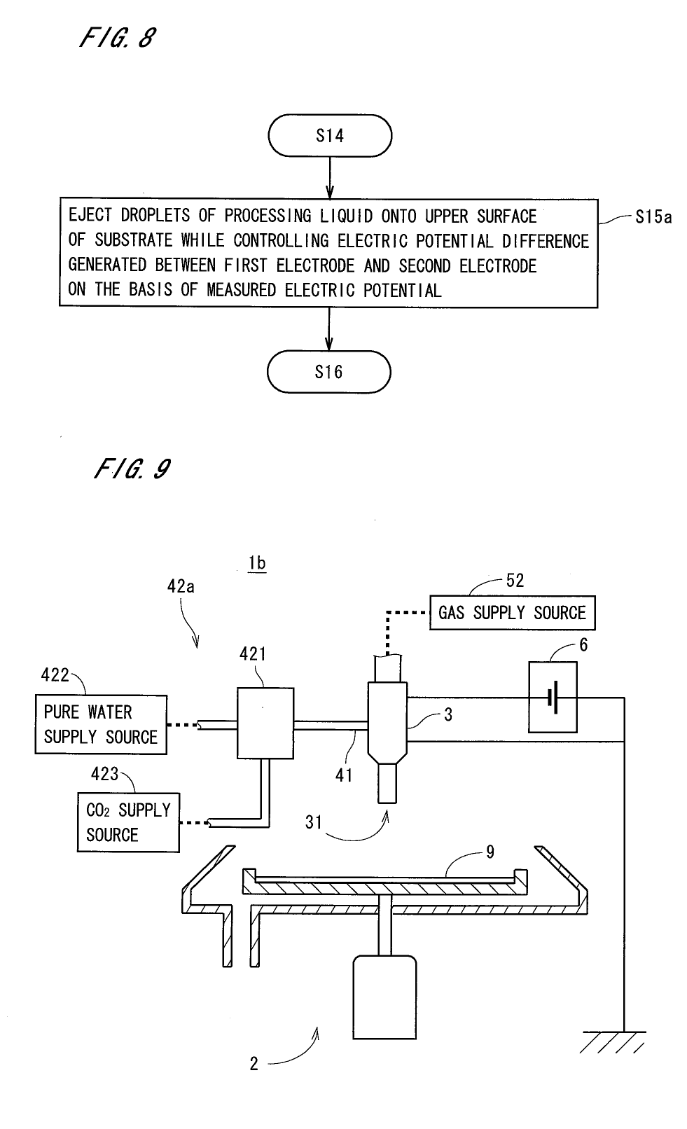

FIG. 8 is a flowchart showing a part of an operation flow for cleaning the substrate 9 in the substrate processing apparatus 1a. In the substrate processing apparatus 1a, Step S15a in FIG. 8 is performed instead of Step S15 in FIG. 3, and operations before and after Step S15a are the same as those of Steps S11 to S14 and Steps S16 to S18 in FIG. 3, respectively.

In cleaning of the substrate 9 performed in the substrate processing apparatus 1a, after the substrate 9 is held by the substrate holding part 2, rotation of the substrate 9 is started (FIG. 3: Steps S11, S12), like in the first preferred embodiment. Subsequently, an electric potential difference is generated between the first electrode 61 (see FIG. 2) and the second electrode 62 (Step S13), oscillation of the nozzle 3 is started (Step S14), and then fine droplets of processing liquid are ejected onto the upper surface of the substrate 9 from the nozzle 3 by supplies of processing liquid and gas from the processing liquid supply pipe 41 and the gas supply pipe 51. At this time, charge is induced on the processing liquid by the first electrode 61 and the second electrode 62, to generate charged droplets.

In the substrate processing apparatus 1a, an electric potential on the upper surface of the substrate 9 is measured by the surface electrometer 73 in parallel with generation of the electric potential difference and ejection of the droplets from the nozzle 3, and an output from the power supply 6 is controlled by the control part 63 on the basis of an output from the surface electrometer 73 (i.e., the output from the surface electrometer 73 is the electric potential measured by the surface electrometer 73, and hereinafter referred to as “measured electric potential”). Thus, the electric potential difference generated between the first electrode 61 and the second electrode 62 is controlled to adjust a charge applied to the droplets (Step S15a).

Proportional control, PID control, or the like are used for control of the electric potential difference by the control part 63. The electric potential difference is made larger according to increase of a surface charge in the upper surface of the substrate 9 (i.e., increase of the absolute value of the measured electric potential), and it is therefore possible to increase an amount of charge induced on the processing liquid and efficiently suppress charging of the substrate 9. Also, it is possible to prevent the substrate 9 from being charged to a reverse electric potential (reverse polarity) because of excessive induction of charge. After cleaning of the substrate 9 is finished, rotation of the substrate 9 is continued to dry the substrate 9, then it is stopped and the substrate 9 is unloaded from the substrate processing apparatus 1a (Steps S16 to S18).

FIG. 9 is a view showing a construction of a substrate processing apparatus 1b in accordance with the third preferred embodiment of the present invention. In the third preferred embodiment, cleaning is performed on a substrate 9 which can be cleaned with processing liquid other than pure water, and specifically, a CO₂-dissolved water where CO₂ gas is dissolved into pure water is used as the processing liquid. The nozzle moving mechanism (see the reference sign 7 in FIG. 1) for moving the nozzle 3 relatively to the substrate 9 in parallel with the upper surface of the substrate 9 is not shown in FIG. 9.

In the substrate processing apparatus 1b, a processing liquid supply part 42a is provided instead of the processing liquid supply source 42 of FIG. 1, and the processing liquid supply part 42a has a gas-liquid mixer 421, a pure water supply source 422 and a CO₂ supply source 423. The gas-liquid mixer 421 is connected to the pure water supply source 422 and the CO₂ supply source 423, respectively. A gas-dissolving membrane, which is formed of hollow fiber membrane or the like and has gas permeability and liquid impermeability, is provided in the gas-liquid mixer 421. An internal space of the gas-liquid mixer 421 is separated into two supply spaces by the gas-dissolving membrane, and pure water and CO₂ gas are supplied into the two supply spaces, respectively. Since a pressure of the CO₂ gas is made higher than that of the pure water, the CO₂ gas passes through the gas-dissolving membrane and dissolves into the pure water to generate a CO₂-dissolved water. The CO₂-dissolved water is supplied to the nozzle 3 as the processing liquid through the processing liquid supply pipe 41. Unwanted gas dissolved into the pure water is degassed by a vacuum pump which is not shown.

In the gas-liquid mixer 421, a supply pressure and the like of the CO₂ gas and the pure water are controlled so that a resistivity of the CO₂-dissolved water becomes a predetermined value. Preferably, the resistivity of the CO₂-dissolved water is made to be equal to or greater than 1×10² Ωm and equal to or smaller than 4×10³ Ωm (from the view point of simplification of the gas-liquid mixer 421 or the like, more preferably, it is made to be equal to or greater than 5×10² Ωm and equal to or smaller than 4×10³ Ωm), and the resistivity is about 1×10³ Ωm in the present preferred embodiment.

In the substrate processing apparatus 1b, like in the first preferred embodiment, the processing liquid is supplied to the nozzle 3 from the processing liquid supply part 42a and carrier gas is supplied to the nozzle 3 from the gas supply source 52 to generate droplets of the processing liquid in the nozzle 3, and the droplets are ejected onto the upper surface of the substrate 9 from the ejection outlet 31. At this time, an electric potential difference is generated between the first electrode 61 (see FIG. 2) and the second electrode 62 in the nozzle 3 by the power supply 6, and charged droplets are thereby ejected onto the substrate 9. The whole operation of the substrate processing apparatus 1b is the same as in FIG. 3, and while the droplets are ejected onto the substrate 9, the substrate 9 rotates by the substrate holding part 2 and the nozzle 3 oscillates, to clean the whole substrate 9. Induction of charge on the processing liquid in the nozzle 3 is continuously performed while ejection of the droplets is performed.

In the substrate processing apparatus 1b, the CO₂-dissolved water with a resistivity which is lower than that of pure water is used as the processing liquid and the substrate 9 is cleaned by the droplets of the processing liquid where positive charge (i.e., the charge having an opposite polarity to that of the electric potential of the substrate after cleaning is performed without generation of the electric potential difference) is induced, and it is therefore possible to suppress charging of the substrate 9 because of the cleaning process more efficiently than in the first preferred embodiment. Since the CO₂ gas dissolved into the cleaning solution is removed from the upper surface of the substrate 9 in a drying process after cleaning, a rinsing process of the substrate 9 is unnecessary, thereby achieving simplification of the cleaning process of the substrate 9.

In the substrate processing apparatus 1b, liquid where rare gas such as xenon (Xe) or gas such as methane is dissolved into pure water may be used as the processing liquid, instead of the CO₂-dissolved water. Also in this case, a resistivity of the processing liquid is lower than that of pure water, and therefore, it is possible to suppress charging of the substrate 9 because of the cleaning process, by cleaning the substrate 9 with the droplets of the processing liquid where charge is induced. Since the gas dissolved into the processing liquid is removed from the substrate 9 in the drying process after cleaning, the rinsing process of the substrate 9 is unnecessary, thereby achieving simplification of the cleaning process of the substrate 9.

Further, the processing liquid may be generated by mixing liquids. In this case, a mixing valve is provided instead of the gas-liquid mixer 421 and a chemical solution supply source is provided instead of the CO₂ supply source 423. From the chemical solution supply source, for example, diluted hydrochloric acid is supplied to the mixing valve and a very small quantity of diluted hydrochloric acid is mixed with pure water in the mixing valve, to generate processing liquid with a resistivity which is lower than that of the pure water, and the processing liquid is supplied to the nozzle 3 through the processing liquid supply pipe 41. A resistivity of the processing liquid is made to be equal to or greater than 1×10² Ωm and equal to or smaller than 4×10³ Ωm (more preferably, equal to or greater than 5×10³ Ωm and equal to or smaller than 4×10³ Ωm).

Since the resistivity of the processing liquid is made to be equal to or greater than 1×10² Ωm (preferably, equal to or greater than 5×10² Ωm), it is possible to prevent the acidity of the processing liquid from being excessively strong and prevent influences such as damage on a wiring formed on the substrate 9 because of contact with the processing liquid. Since the resistivity of the processing liquid is made to be equal to or smaller than 4×10³ Ωm, it is possible to further suppress charging of the substrate 9. In the substrate processing apparatus 1b, aqueous solution where chemical solution such as ammonia solution (NH₃) or hydrogen peroxide solution (H₂O₂) is slightly mixed with pure water may be used as the processing liquid, instead of diluted hydrochloric acid.

As discussed above, the substrate processing apparatus 1b is suitable for processing of the substrate 9 where processing liquid other than nonconductive processing liquid can be used.

Though the preferred embodiments of the present invention have been discussed above, the present invention is not limited to the above-discussed preferred embodiments, but allows various variations.

For example, the above cleaning process may be continuously performed on a plurality of substrates 9 in the substrate processing apparatus. In this case, the electric potential difference generated between the first electrode 61 and the second electrode 62 may be kept in loading and unloading of the substrates 9. Generation of the electric potential difference, for example, may be performed by grounding the first electrode 61 and connecting the second electrode 62 to the power supply 6 or may be performed by connecting the both electrodes of the power supply 6 to the first electrode 61 and the second electrode 62, respectively. From the viewpoint of simplification of the constructions of the substrate processing apparatus and the nozzle 3, however, it is preferable that one of the first electrode 61 and the second electrode 62 is grounded.

In the substrate processing apparatuses in accordance with the above preferred embodiments, a polarity of electric potential and an amount of charge of the substrate which are created in cleaning are different depending on a kind of a substrate (for example, a kind of insulating film or a kind of wiring metal which are formed on an upper surface of a semiconductor substrate and both kinds of insulating film and wiring metal), and therefore, the electric potential difference generated between the first electrode 61 and the second electrode 62 in the substrate processing apparatus is changed according to a kind of a substrate. For example, in a case where a resist film is formed on a substrate, since the upper surface of the substrate is positively charged by cleaning, a voltage which is positive relatively to the second electrode 62 is applied to the first electrode 61 and negative charge is induced on the processing liquid.

In the first and second preferred embodiments, liquid other than pure water can be utilized as the nonconductive processing liquid and for example, a ZEORORA (trademark) of ZEON Corporation or a Novec (trademark) HFE of 3M Company, which are fluorine-based cleaning solutions, can be used as the cleaning solution.

Although the first electrode 61 is formed by plating in the first preferred embodiment, the first electrode 61 may be provided by press-fitting or embedding of metal. The first electrode 61 may be formed of conductive resin or conductive carbon, and in a case where there is no problem the processing liquid contacts with metal or the like, the second electrode 62 and the outer cylindrical member 33 of FIG. 5 can be formed of metal or other conductive member. The first electrode 61 and the second electrode 62 are not necessary to be a ring shape around the central axis 30.

In the substrate processing apparatus 1b in accordance with the third preferred embodiment, the gas-liquid mixer 421 or the mixing valve for generating the processing liquid is not necessarily provided, but processing liquid generated in other apparatus may be supplied to the nozzle 3. In the third preferred embodiment, there may be a case where an electric potential on the substrate 9 is measured and an electric potential difference generated between the first electrode 61 and the second electrode 62 is controlled like in the second preferred embodiment.

The substrate processing apparatuses in accordance with the above preferred embodiments may be utilized in various stages other than cleaning of a substrate, and may be utilized, for example, in a rinsing process of a substrate cleaned with a chemical solution. In this case, a rinse agent such as pure water is used as processing liquid applied onto a substrate. Also, an object to be processed in the substrate processing apparatus may be various substrates such as a printed circuit board or a glass substrate for a flat panel display, as well as a semiconductor substrate.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2006-337765 filed in the Japan Patent Office on Dec. 15, 2006, the entire disclosure of which is incorporated herein by reference.

What is claimed is:

1. A two-fluid nozzle for ejecting droplets of processing liquid onto an object to be processed, comprising:
a processing liquid passage through which processing liquid flows;
a gas passage through which gas flows;
a droplet generation part which mixes said processing liquid from said processing liquid passage and said gas from said gas passage to generate droplets and ejects said droplets toward a predetermined ejection direction together with said gas;
a first electrode provided in said gas passage in the vicinity of said droplet generation part; and
a second electrode which contacts said processing liquid in said processing liquid passage or said droplet generation part, wherein
an electric potential difference is generated between said first electrode and said second electrode.

2. The two-fluid nozzle according to claim 1, wherein
said droplet generation part comprises a cover covering a mixing area of said processing liquid and said gas and having an ejection outlet, and
said second electrode is provided in said cover.

3. The two-fluid nozzle according to claim 2, wherein
said gas is ejected from said gas passage toward a central portion of said mixing area,
said processing liquid from said processing liquid passage is supplied around flow of said gas in said mixing area, and
said second electrode is a ring shape surrounding said flow of said gas.

4. The two-fluid nozzle according to claim 2, wherein
said cover and said second electrode are formed as one conductive member.

5. The two-fluid nozzle according to claim 1, wherein
said second electrode is formed of conductive resin or conductive carbon.

6. The two-fluid nozzle according to claim 1, wherein
a distance between said first electrode and a mixing area of said processing liquid and said gas is equal to or shorter than 5 cm.

7. The two-fluid nozzle according to claim 1, wherein
one of said first electrode and said second electrode is grounded.

8. The two-fluid nozzle according to claim 1, wherein
said processing liquid is liquid where CO₂ gas is dissolved into pure water.

9. The two-fluid nozzle according to claim 1, wherein
a resistivity of said processing liquid is equal to or greater than 1×10² Ωm and equal to or smaller than 4×10³ Ωm.

10. The two-fluid nozzle according to claim 1, wherein
said processing liquid has nonconductivity.

11. A substrate processing apparatus for processing a substrate, comprising:
a holding part for holding a substrate;
a two-fluid nozzle for ejecting droplets of processing liquid onto a main surface of said substrate; and
a power supply connected to said two-fluid nozzle, wherein
said two-fluid nozzle comprises:
a processing liquid passage through which processing liquid flows;
a gas passage through which gas flows;
a droplet generation part which mixes said processing liquid from said processing liquid passage and said gas from said gas passage to generate droplets and ejects said droplets toward a predetermined ejection direction together with said gas;
a first electrode provided in said gas passage in the vicinity of said droplet generation part; and
a second electrode which contacts said processing liquid in said processing liquid passage or said droplet generation part, and
said power supply generates an electric potential difference between said first electrode and said second electrode.

12. The substrate processing apparatus according to claim 11, further comprising:
a surface electrometer for measuring an electric potential on said main surface of said substrate; and
a control part for controlling an electric potential difference generated between said first electrode and said second electrode on the basis of an output from said surface electrometer in parallel with ejection of said droplets from said two-fluid nozzle.

13. The substrate processing apparatus according to claim 11, wherein
said droplet generation part comprises a cover covering a mixing area of said processing liquid and said gas and having an ejection outlet, and
said second electrode is provided in said cover.

14. The substrate processing apparatus according to claim 13, wherein
said gas is ejected from said gas passage toward a central portion of said mixing area,
said processing liquid from said processing liquid passage is supplied around flow of said gas in said mixing area, and
said second electrode is a ring shape surrounding said flow of said gas.

15. The substrate processing apparatus according to claim 13, wherein
said cover and said second electrode are formed as one conductive member.

16. The substrate processing apparatus according to claim 11, wherein
said second electrode is formed of conductive resin or conductive carbon.

17. The substrate processing apparatus according to claim 11, wherein
a distance between said first electrode and a mixing area of said processing liquid and said gas is equal to or shorter than 5 cm.

18. The substrate processing apparatus according to claim 11, wherein
one of said first electrode and said second electrode is grounded.

19. A substrate processing method of processing a substrate, comprising the steps of:
a) ejecting droplets of processing liquid onto a main surface of a substrate from a two-fluid nozzle which comprises a processing liquid passage through which said processing liquid flows, a gas passage through which gas flows, a droplet generation part which mixes said processing liquid from said processing liquid passage and said gas from said gas passage to generate droplets and ejects said droplets toward a predetermined ejection direction together with said gas; and
b) inducing charge on said droplets in parallel with said step a) by generating an electric potential difference between a first electrode provided in said gas passage in the vicinity of said droplet generation part and a second electrode which contacts said processing liquid in said processing liquid passage or said droplet generation part.

20. The substrate processing method according to claim 19, further comprising, in parallel with said steps a) and b), the step of
c) measuring an electric potential on said main surface of said substrate and controlling an electric potential difference generated between said first electrode and said second electrode on the basis of said electric potential.

21. The substrate processing method according to claim 19, wherein
said step b) is continuously performed while said step a) is performed.
